(19) United States
(12) Patent Application Publication
(10) Pub. No.: US 2018/0157425 A1
(43) Pub. Date: Jun. 7, 2018

(54) STORAGE CONTROL APPARATUS, STORAGE APPARATUS, AND NON-TRANSITORY COMPUTER-READABLE RECORDING MEDIUM HAVING CONTROL PROGRAM STORED THEREIN

(71) Applicant: FUJITSU LIMITED, Kawasaki-shi (JP)

(72) Inventor: Kenji Uchiyama, Kawasaki (JP)

(73) Assignee: FUJITSU LIMITED, Kawasaki-shi (JP)

(21) Appl. No.: 15/806,677

(22) Filed: Nov. 8, 2017

(30) Foreign Application Priority Data
Dec. 5, 2016 (JP) 2016-235966

(51) Int. Cl. G06F 3/06; G06F 13/18

(52) U.S. Cl. CPC G06F 3/0611; G06F 3/0665; G06F 3/0685; G06F 3/0689; G06F 13/18

(57) ABSTRACT

A storage control apparatus includes a memory and a processor coupled to the memory. The processor is configured to identify respective storage groups to which a plurality of storing devices to apply firmware belong, from a plurality of storage groups that are process targets according to an access request from an upper apparatus; and set respective priorities for an application process of the firmware to the identified storage groups, based on estimated values of processing time according to the access request for each of the identified storage groups. The processor is also configured to execute the application process on storing devices belonging to storage groups to which the priorities are set, in execution orders in accordance with the priorities that are set; and execute a process according to the access request on storage groups other than the storage groups to which the application process is being executed.

### CROSS-REFERENCE TO RELATED APPLICATION

This application is based upon and claims the benefit of priority of the prior Japanese Patent Application No. 2016-235966, filed on Dec. 5, 2016, the entire contents of which are incorporated herein by reference.

### FIELD

The present disclosure relates to a storage control apparatus, storage apparatus, and a non-transitory computer-readable recording medium having a control program stored therein.

### BACKGROUND

A virtual tape library apparatus is known which includes a library accommodating multiple portable media, e.g., magnetic tape cartridges and optical disk cartridges, and a disk array apparatus. Such a virtual tape library apparatus stores data written from a host apparatus, in a disk array apparatus used as a primary cache. In such a virtual tape library apparatus, the disk array apparatus is referred to as the “tape volume cache (TVC)”.

The disk array apparatus manages multiple storing devices, such as disks, e.g., hard disk drives (HDDs) and solid state drives (SSDs), in a unit of a group of redundant arrays of inexpensive disks (RAID), for example. In the RAID, even in a case where data cannot be read from a part of disks, the data can be recovered from the rest of the disks and thus it is possible to increase the reliability of data.

Inside disks in a TVC, firmware (hereinafter may also referred to as “FW”, “disk FW”, or “disk firm”) is accommodated. For applying FW (e.g., an updated version of FW) to disks in a TVC, data read/write processes from and to the disks are to be suspended. As a result, accesses from a host apparatus to virtual tape library apparatus are restricted while FW is being applied.

As a related technique, a technique is known in which target RAID groups are divided into two based on application time of FW, in order to achieve continuous accesses from a host apparatus while FW is being applied.

In this technique, the FW is applied to a first group of the two groups, and a second group handles processes related to host input/outputs (I/Os), for example. At this time, on-cache logical volumes (LVs) are processed preferentially.

Upon processing a host I/O to an LV that is off-cache, and is stored in a file system on the first group to which the FW is being applied, a file system on the second group is used which can process the host I/O for the corresponding LV.
Patent Document 1: Japanese Laid-open Patent Publication No. 2016-157270
Patent Document 2: Japanese Laid-open Patent Publication No. 2008-217202
Patent Document 3: Japanese Laid-open Patent Publication No. 2002-318666
Patent Document 4: Japanese Laid-open Patent Publication No. 2009-282834

The above-described technique to group RAID groups into two may experience the following problem when an I/O process associated with a large amount of data, such as an I/O process for a full backup or a full restore of the system, is carried out on disks to which the FW is to be applied. Note that the “large amount of data” refers to data of which time to process an I/O (e.g., time until a read and write is completed) is longer than the time to apply FW (FW application time), for example.

When such an I/O process associated with a large amount of data is present, the I/O process on the second group may not be completed while the FW is being applied in the first group. This may result in a situation where either the application of the FW to the first group or an access from a host apparatus is to be suspended.

Stated differently, the availability of a virtual tape library apparatus may be reduced due to an FW application on a disk array apparatus.

Note that the problem as described above is not limited to a disk array apparatus provided in a virtual tape library apparatus, and may similarly arise in a wide variety of storage apparatuses having multiple storing devices.

### SUMMARY

According to an aspect of the embodiments, a storage control apparatus may include a memory and a processor coupled to the memory. The processor may be configured to identify respective storage groups to which a plurality of storing devices to apply firmware belong, from a plurality of storage groups that are process targets according to an access request from an upper apparatus. The processor may also be configured to set respective priorities for an application process of the firmware to the identified storage groups, based on estimated values of processing time according to the access request for each of the identified storage groups. The processor may further be configured to execute the application process on storing devices belonging to storage groups to which the priorities are set, in execution orders in accordance with the priorities that are set. The processor may further be configured to execute a process according to the access request on storage groups other than the storage groups to which the application process is being executed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a flowchart depicting an example of operations of an FW application process according to a comparative example;

FIG. 2 is a diagram depicting an example of operations of an FW application process according to the comparative example;

FIG. 3 is a block diagram depicting an example of a configuration of a system according to one embodiment;

FIG. 4 is a block diagram depicting an example of a hardware configuration of a hierarchical control server;

FIG. 5 is a block diagram depicting an example of a functional configuration of the hierarchical control server;

FIG. 6 is a diagram depicting one example of file systems in a virtual tape library apparatus;

FIG. 7 is a diagram depicting one example of a disk information table;

FIG. 8 is a diagram depicting one example of a RAID group information table;

FIG. 9 is a diagram depicting one example of a file system information table;

FIG. 10 is a flowchart depicting an example of operations of an FW application division number calculation process by an FW application controller;

FIG. 11 is a flowchart depicting the example of the operations of the FW application division number calculation process by the FW application controller;

FIG. 12 is a diagram depicting one example of calculation results of processing time of on-cache LVs (after they are sorted);

FIG. 13 is a flowchart depicting an example of operations of an FW application priority decision process;

FIG. 14 is a diagram depicting one example of processing time of on-cache LVs for respective RAID groups;

FIG. 15 is a flowchart depicting the example of the operations of the FW application priority decision process;

FIG. 16 is a diagram depicting one example of priorities for the respective RAID groups;

FIG. 17 is a flowchart depicting an example of operations of an FW application process;

FIG. 18 is a diagram depicting examples of states of the respective RAID groups before an application of FW;

FIG. 19 is a diagram depicting examples of states of the respective RAID groups during processing of a first step of the FW application;

FIG. 20 is a diagram depicting one example of state changes of the file system information table;

FIG. 21 is a diagram depicting one example of a state change of the disk information table;

FIG. 22 is a diagram depicting examples of states of the respective RAID groups during processing of a second step of the FW application;

FIG. 23 is a diagram depicting one example of the state changes of the file system information table;

FIG. 24 is a diagram depicting one example of the state changes of the disk information table;

FIG. 25 is a diagram depicting examples of states of the respective RAID groups during processing of a third step of the FW application; and

FIG. 26 is a diagram depicting one example of the state changes of the file system information table.

### DESCRIPTION OF EMBODIMENTS

Hereinafter, embodiments of the present invention will be described with reference to the drawings. Note that the embodiments described below are merely exemplary, and it is not intended to exclude a wide variety of modifications and applications of techniques that are not described explicitly in the following. For example, the present embodiments may be practiced in various modifications without departing from the spirit thereof. Note that, in the drawings referenced to in the following descriptions, elements denoted by the same reference symbols refer to the same or similar elements, unless otherwise stated.

### [1] One Embodiment

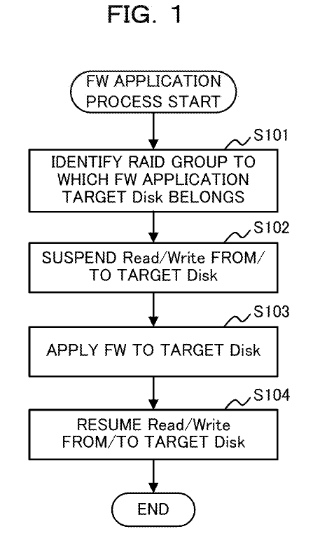

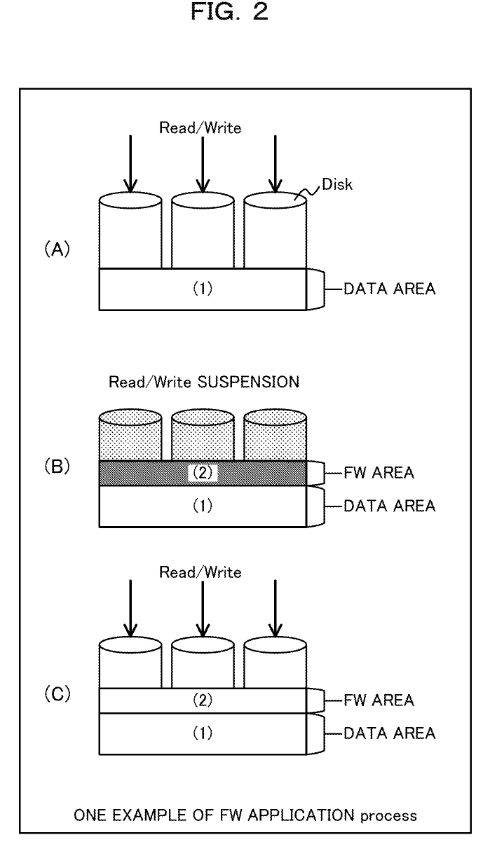

Initially, referring to FIGS. 1 and 2, an FW application process according to a comparative example will be described.

As exemplified in FIG. 1, a server that controls a TVC in a virtual tape library apparatus identifies a RAID group to which FW application target disks belong, in the TVC (Step S101), and causes reads and writes from and to the target disks to suspend (Step S102).

Subsequently, the server applies FW for an update, to the target disks (Step S103). After the application of the FW completes, the server resumes reads and writes from and to the target disks (Step S104) and the process ends.

For example, as depicted in FIG. 2, if data is being read and written from and to target disks before FW is applied (refer to (a) in FIG. 2), the server suspends those reads and writes, and applies the firmware to the disks during the suspension (refer to (b) in FIG. 2). The server then resumes reads and writes to and from the disks as usual after the application of the FW completes (refer to (c) in FIG. 2).

In the FW application process according to the comparative example, since host I/Os to all disks in FW application target RAID groups are suspended, the availability of a virtual tape library apparatus while the FW is being applied may be reduced.

In addition, as described above, in the technique to group RAID groups into two, when one group handles I/O processes of a large amount of data during an application of FW to the other group, those I/O processes may not be completed. In such a case, either the application of the FW to the other group or an access from a host apparatus is to be suspended, and the availability of a virtual tape library apparatus may be reduced as a result.

Accordingly, in one embodiment, a system will be described which suppresses a reduction in the availability of a storage apparatus by executing an FW application process on respective RAID groups while continuously processing inputs and outputs from and to a virtual tape library apparatus.

### [1-1] Example of Configuration of System

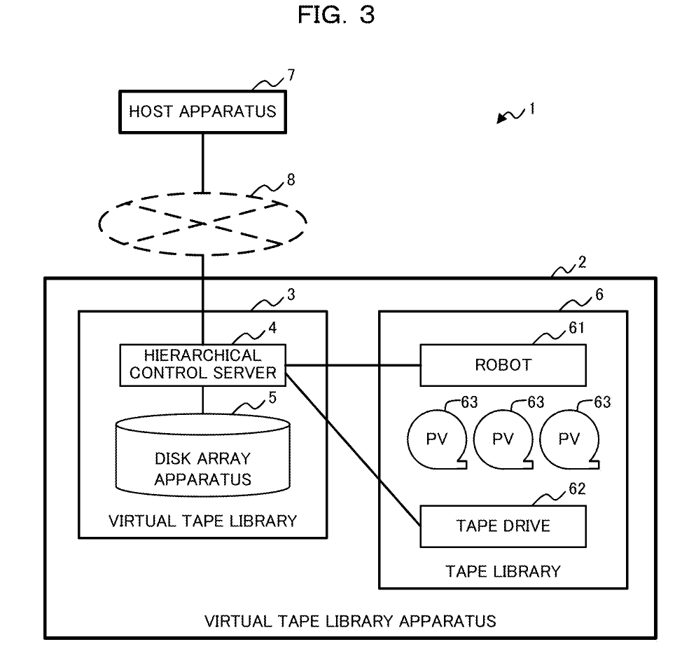

As depicted in FIG. 3, a system 1 according to one embodiment may include a virtual tape library apparatus 2 and a host apparatus 7 connected to the virtual tape library apparatus 2, for example.

The host apparatus 7 is one example of an upper apparatus configured to carry out I/Os, such as reads and writes, from and to the virtual tape library apparatus 2, which designates logical volumes as access targets. Note that, in the following descriptions, the term “I/O” refers to an access request including at least information specifying an access target and data to be written (in a case of a write access).

Examples of the host apparatus 7 include computers, such as a server, a personal computer (PC), a tablet, and a personal digital assistant (PDA). Note that the host apparatus 7 may be directly connected to the virtual tape library apparatus 2, bypassing a network 8.

In the example in FIG. 3, a network 8 may intervene between the virtual tape library apparatus 2 and the host apparatus 7. Examples of the network 8 include a Storage Area Network (SAN), and may also include intranets, such as a local area network (LAN) and a wide area network (WAN), and the Internet.

The virtual tape library apparatus 2 is a system that provides the host apparatus 7 with a virtual tape library, and may include a virtual tape library 3 and a tape library 6, for example.

The virtual tape library 3 is one example of a storage apparatus. The virtual tape library 3 may include a hierarchical control server 4 and a disk array apparatus 5, for example.

The hierarchical control server 4 is one example of a storage control apparatus or information processing apparatus configured to carry out hierarchical controls by means of the disk array apparatus 5 and the tape library 6. Examples of the hierarchical control server 4 include computers, such as a server and a PC. The hierarchical control server 4 may carry out input/output controls on the host apparatus 7, RAID managements and controls on the disk array apparatus 5, and hierarchical controls on the disk array apparatus 5 and the tape library 6, for example.

The disk array apparatus 5 is used as a primary cache of the virtual tape library apparatus 2. Hereinafter, the disk array apparatus 5 may also be denoted as the “TVC 5”. The disk array apparatus 5 may include a plurality of storing devices (not illustrated), and may configure multiple RAID groups using those storing devices under the control of the hierarchical control server 4. Note that a RAID group is one example of a storage group to which a plurality of storing devices belong. In one embodiment, multiple RAID groups may store logical volumes of data stored in each of one or more portable media of the plurality of portable media in the tape library 6.

Examples of the plurality of storing devices provided in the disk array apparatus 5 include magnetic disk devices (e.g., HDDs), semiconductor drive devices (e.g., SSDs), non-volatile memories, for example. Examples of the non-volatile memories include a flash memory, a storage class memory (SCM), and a read only memory (ROM), for example.

The tape library 6 is one example of a library apparatus accommodating a plurality of portable media. As depicted in FIG. 3, the tape library 6 may include a robot 61 and a tape drive 62, for example. Note that multiple robots 61 and multiple tape drives 62 may be provided to the tape library 6.

In addition, a plurality of portable media 63 may also be accommodated in the library 6. Note that examples of the portable media 63 include physical volumes (PVs), such as magnetic tape cartridges, magneto-optical tape cartridges, optical disks, and optical disk cartridges. Hereinafter, the portable media 63 may also be denoted as the “PVs 63”.

The robot 61 is one example of a transportation apparatus configured to pick up and transport the PVs 63, and to insert or connect a PV 63 to the tape drive 62.

The tape drive 62 is one example of a medium processing apparatus configured to carry out a wide variety of accesses, such as writes and reads (e.g., records and playbacks), to and from a PV 63 that is inserted or connected.

In the virtual tape library apparatus 2 described above, the hierarchical control server 4 serves as a conventional tape library (Library; LIB) for the host apparatus 7, in response to a read/write request of data from the host apparatus 7, for example.

For example, the hierarchical control server 4 reads or writes data from or to an LV and the like, using the TVC 5. Because the hierarchical control server 4 returns a response to the host apparatus 7 using the disk array apparatus 5 that has a higher data access performance than that of the tape library 6, the hierarchical control server 4 can carry out processes faster, as compared to cases wherein only the tape library 6 is used.

Note that the hierarchical control server 4 saves an LV written in the TVC 5 to a PV 63 in the tape library 6 in the background, without requiring any interventions of the host apparatus 7. The process to save to a PV may be referred to as a “migration process”, for example.

Further, in order to prevent shortage of free space in the TVC 5 due to LVs written in the TVC 5, the hierarchical control server 4 erases, from the TVC 5, an LV of a large volume that has not been updated frequently and that has already been migrated.

Furthermore, when an LV of which read or write is requested by the host apparatus 7, is present in the TVC 5 (when the LV is on-cache), the hierarchical control server 4 reads that LV from a disk in the TVC 5 to make a response to the host apparatus 7.

In contrast, when the LV of which read or write is requested by the host apparatus 7 is not present in the TVC 5 (in the case of a cache miss), the hierarchical control server 4 loads the data of that LV from the tape library 6 to the TVC 5 to make a response to the host apparatus 7. The load of the data to the TVC 5 may be achieved by inserting the target PV 63 in the tape library 6 to the tape drive 62, reading, from the tape drive 62, the LV that has been migrated, and transferring data of the LV to the TVC 5.

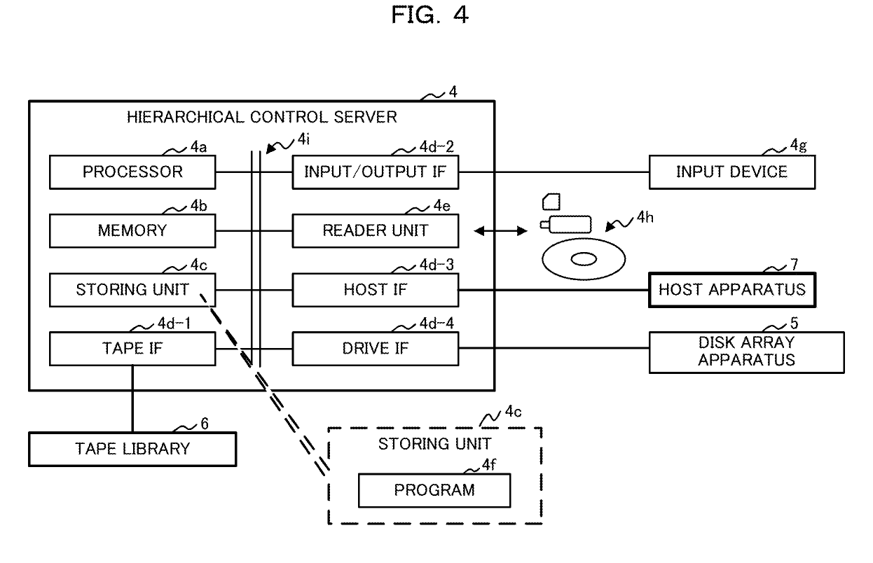

Next, referring to FIG. 4, an example of a hardware configuration of the hierarchical control server 4 will be described. As depicted in FIG. 4, the hierarchical control server 4 may include a processor 4a, a memory 4b, a storing unit 4c, a tape IF (Interface) 4d-1, an input/output IF 4d-2, a host IF 4d-3, a drive IF 4d-4, and a reader unit 4e, for example.

The processor 4a is one example of a computation processing unit configured to carry out a wide variety of controls and computations. The processor 4a may be communicatively connected to the blocks 4b-4e through a bus 4i. As the processor 4a, an integrated circuit (IC), such as a CPU, an MPU, a DSP, an ASIC, and a PLD (e.g., an FPGA), may be used. Note that CPU is an abbreviation for central processing unit, MPU is an abbreviation for micro processing unit, and DSP is an abbreviation for digital signal processor. Further, ASIC is an abbreviation for application specific integrated circuit, PLD is an abbreviation for programmable logic device, and FPGA is an abbreviation for field programmable gate array.

The memory 4b is one example of hardware configured to store a wide variety of data and programs. Examples of the memory 4b include volatile memories, such as a random access memory (RAM), for example.

The storing unit 4c is one example of hardware configured to store a wide variety of data and programs, and the like. For example, the storing unit 4c may be used as a secondary storing device of the hierarchical control server 4, and may store firmware programs and a wide variety of data. Examples of the storing unit 4c include a wide variety of storing devices, such as magnetic disk devices (e.g., HDDs), semiconductor drive devices (e.g., SSDs), and non-volatile memories, for example. The storing unit 4c may store a program 4f that embodies all or a part of functions of the hierarchical control server 4.

Each of the tape IF 4d-1, the input/output IF 4d-2, the host IF 4d-3, and the drive IF 4d-4 is one example of a communication interface configured to carry out controls and other operations on connections and communications among the tape library 6, the input device 4g, the host apparatus 7, and the disk array apparatus 5. The input device 4g may include a mouse, a keyboard, a touch panel, operation buttons, and the like, for example. The input/output IF 4d-2 may carry out controls and other operations on connections and communications with output devices (not illustrated), such as a display or a printer.

Note that the hierarchical control server 4 may include a communication interface that carries out controls and other operations on connections and communications with an operation terminal for operators, and may download the program 4f from the network 8 or another unillustrated network by means of that communication interface.

The reader unit 4e is one example of reader configured to read data and programs recorded in a recording medium 4h, and output them to the processor 4a. The reader unit 4e may include a connection terminal or device to which a recording medium 4h can be connected or inserted. Examples of the reader unit 4e include an adaptor compliant with standards, e.g., the Universal Serial Bus (USB) standard, a drive apparatus to access a recording disk, and a card reader to access a flash memory (e.g., an SD card), for example. Note that the program 4f may be stored in the recording medium 4h.

Examples of the recording medium 4h may include non-transitory computer-readable recording media, such as magnetic/optical disks and flash memories, for example. Examples of magnetic/optical disks may include flexible disks, compact disks (CDs), digital versatile disks (DVDs), Blu-ray disks, and holographic versatile discs (HVDs), for example. Examples of flash memories may include solid-state memories, such as USB memories and SD cards, for example. Note that examples of CDs may include a CD-ROM, a CD-R, and a CD-RW, for example. Furthermore, examples of DVDs may include a DVD-ROM, a DVD-RAM, a DVD-R, a DVD-RW, a DVD+R, and a DVD+RW, for example.

The above-described hardware configuration of the hierarchical control server 4 is merely exemplary. Accordingly, the number of hardware in the hierarchical control server 4 may be modified (e.g., any block may be added or deleted), or the hardware may be divided or combined in any combinations, or a bus may be added or omitted, where appropriate.

### [1-2] Example of Functional Configuration of Hierarchical Control Server 4

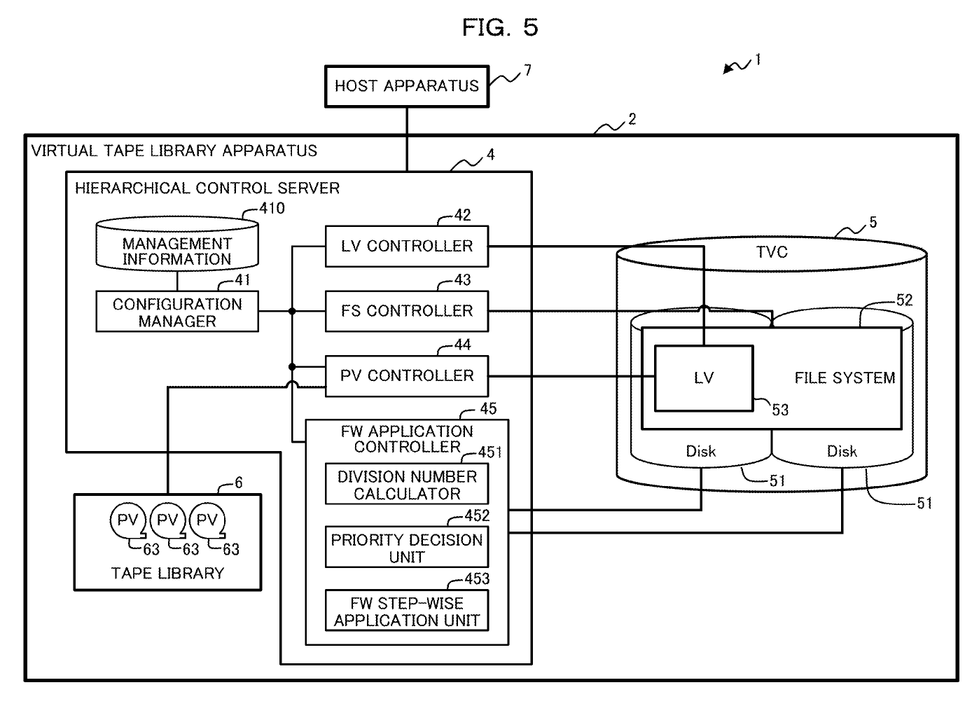

FIG. 5 is a diagram depicting one example of an example of a functional configuration of the hierarchical control server 4. As depicted in FIG. 5, the hierarchical control server 4 may include a configuration manager 41, an LV controller 42, a file system (FS) controller 43, a PV controller 44, and an FW application controller 45, for example. Note that the respective functions of the functional blocks 41-45 may be embodied by the processor 4a depicted in FIG. 4 which expands the program 4f stored in the storing unit 4c in the memory 4b for executing the program 4f, for example.

The configuration manager 41 manages configuration data of the hierarchical control server 4. Examples of the configuration data include information of the LV 53, information of the PVs 63, and information about the TVC 5, for example. In FIG. 5, such information managed by the configuration manager 41 is collectively illustrated as management information 410. Note that the management information 410 may be stored in a part of storage areas in the memory 4b depicted in FIG. 4, for example. Details of the management information 410 will be described later.

The LV controller 42 controls I/Os (e.g., reads and writes) between the host apparatus 7 and the LV 53. For example, the LV controller 42 is one example of an access control unit configured to carry out processes on RAID groups in accordance with an access request from the host apparatus 7, other than a RAID group on which an FW application process is being executed, in cooperation with the FW application controller 45 that will be described later.

The FS controller 43 controls a file system (FS) 52 on the TVC 5. For example, the FS controller 43 may mount or unmount the FS 52.

The PV controller 44 control reads and writes between the LV 53 and the PVs 63.

The FW application controller 45 controls an FW application process to the TVC 5. Details of the FW application controller 45 will be described later.

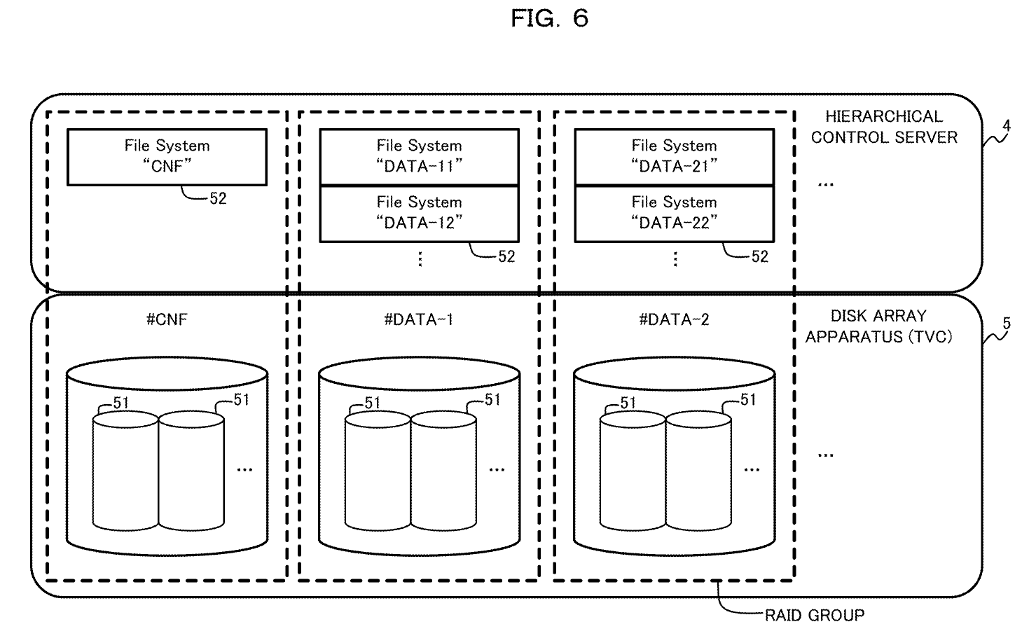

As exemplified in FIG. 6, in the TVC 5, multiple disks 51 are managed as a single RAID group, and one or more file systems (FSs) 52 are created (mounted) on the hierarchical control server 4 for each RAID group. Using the above-described functional blocks, the hierarchical control server 4 can embody controls of I/O to and from the host apparatus 7 in accordance with an I/O from the host apparatus 7, by writing an LV 53 to the FS 52, or reading an LV 53 from a PV 63 in the tape library 6 to the FS 52.

For example, a single FS 52 is created in a RAID group #CNF that is created for storing the configuration data of the virtual tape library apparatus 2, and that FS 52 is mount as the “CNF” (hereinafter may also be denoted as “configuration area” or “management area”) on the hierarchical control server 4.

On the other hand, for each RAID group, N (N≥1) FSs 52 are created in RAID group(s) #DATA-M (M≥1) that have been created for storing user data. These RAID group(s) #DATA-Mare mounted as the “DATA-MN” (hereinafter may also be denoted as “data areas”) on the hierarchical control server 4. Note that M is one example of an identifier of a RAID group, and N is one example of an identifier of an FS 52 in the RAID group.

(With Regard to Management Information 410)

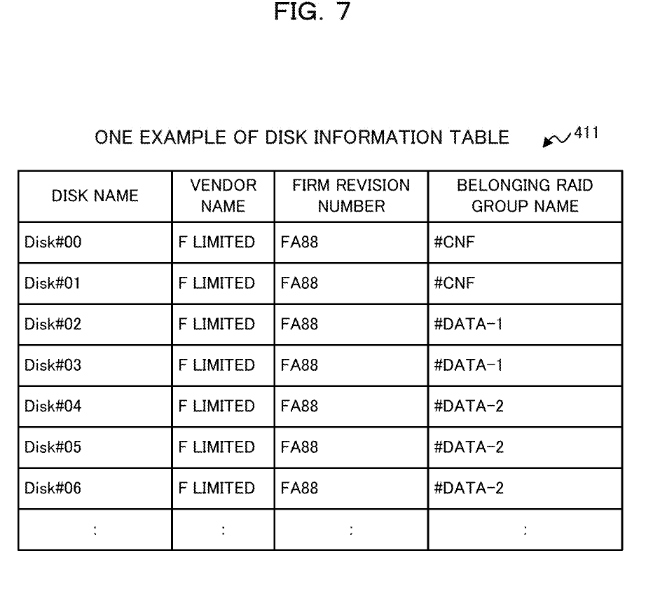

Next, referring to FIGS. 7-9, the management information 410 will be described. As depicted in FIGS. 7-9, the management information 410 may include information of a disk information table 411, a RAID group information table 412, and a file system information table 413, for example. Note that FIGS. 7-9 are illustrated in tabular formats for convenience of descriptions of a wide variety of information (e.g., the ones denoted by reference symbols 411-413) included in the management information 410. Such information, however, is not limited to one in a tabular format, and may be maintained in a wide variety of formats or styles, such as arrays, databases, and bitmaps, for example.

FIG. 7 is a diagram depicting an example of a data structure of the disk information table 411. The disk information table 411 may have the fields of “DISK NAME”, “VENDOR NAME”, “FIRM REVISION NUMBER”, and “BELONGING RAID GROUP NAME” that are set, for example. The “DISK NAME” and the “VENDOR NAME” are one example of an identifier of a disk 51 and an identifier of the vendor that manufactures that disk 51, respectively. The “FIRM REVISION NUMBER” is information indicating a disk firm revision number that is currently being used, and the “BELONGING RAID GROUP NAME” is one example of an identifier of a RAID group to which the disk 51 belongs.

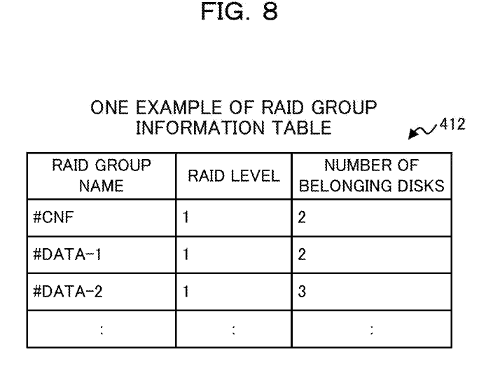

FIG. 8 is a diagram depicting an example of a data structure of the RAID group information table 412. The RAID group information table 412 may have the fields of “RAID GROUP NAME”, “RAID LEVEL”, and “NUMBER OF BELONGING DISKS” that are set, for example. The “RAID GROUP NAME” is one example of an identifier of a RAID group. The “RAID LEVEL” is information indicating a RAID level set to that RAID group, and may include at least one of RAID 0 through RAID 6, or two or more of combinations thereof, for example. The “NUMBER OF BELONGING DISKS” is information indicating the number of disks configuring the RAID group.

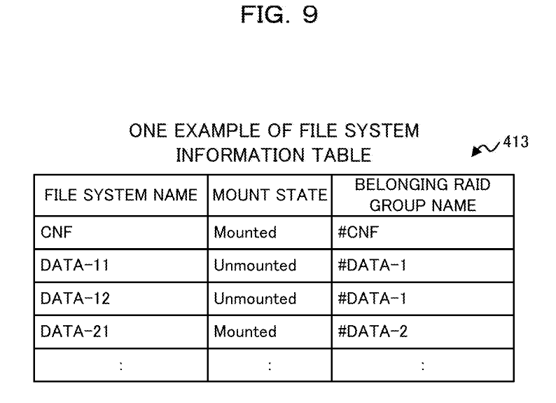

FIG. 9 is a diagram depicting an example of a data structure of the file system information table 413. The file system information table 413 may have the fields of “FILE SYSTEM NAME”, “MOUNT STATE”, and “BELONGING RAID GROUP NAME” that are set, for example. The “FILE SYSTEM NAME” is one example of an identifier of an FS 52 to which an LV 53 belongs. The “MOUNT STATE” is state information indicating whether the FS 52 is mounted on the hierarchical control server 4. The “BELONGING RAID GROUP NAME” is one example of an identifier of a RAID group to which a disk 51 belongs.

The configuration manager 41 may update information of the tables 411-413 in the management information 410 when the configuration or the state of the disks 51, the RAID groups, or the FSs 52, or the like, is modified.

(Description of FW Application Controller 45)

Next, the FW application controller 45 will be described. A process by the FW application controller 45 may be executed when a disk firm (FW) application instruction is issued for a TVC 5 mounted on the virtual tape library apparatus 2, for example. An FW application instruction may be issued in response to an operation on a firm up tool made by a user, for example. Note that a firm up tool may be an application program that is installed on the hierarchical control server 4, the host apparatus 7, an unillustrated operation terminal, or the like, for example.

During a normal operation state of the virtual tape library apparatus 2, the technique to group target RAID groups into two based on the application time of the FW may be applied to the FW application controller 45. In this case, the FW application controller 45 may apply FW to a first group of the two groups, and may use a second group for processes related to host I/Os, for example. Note that the normal operation state refers to the state wherein data I/O having time for processing an I/O shorter than the FW application time, is being input, for example.

Further, when the frequency of I/Os to the virtual tape library apparatus 2 is equal to or lower than a certain level, such as when the an operation of the host apparatus 7 is stopped, the FW application controller 45 may carry out an FW application process using the technique illustrated in FIGS. 1 and 2. For example, the FW application controller 45 may suspend host I/Os to all disks in FW application target RAID groups, and may apply FW to all of the FW application target RAID groups at once.

On the other hand, when an I/O associated with a large amount of data, such as an I/O for a full backup or a full restore, is issued to the virtual tape library apparatus 2, the FW application controller 45 may carry out a step-wise FW application process described below. Note that the “large amount of data” refers to data of which time to process an I/O (e.g., time until a read and write is completed) is longer than the time to apply FW (FW application time), for example.

As exemplified in FIG. 5, in order to carry out the step-wise FW application process, the FW application controller 45 may include a division number calculator 451, a priority decision unit 452, and an FW step-wise application unit 453, for example.

In the following descriptions, it is assumed that all disks 51 provided in the TVC 5 are the same in the virtual tape library apparatus 2, and that an FW application process is to be executed to all of the disks 51 except for a configuration area. Because it is not possible to apply FW to the configuration area during an operation, the FW application controller 45 may exclude the configuration area from targets of a step-wise FW application process. For example, the FW application controller 45 may reject the configuration area such that no FW application is executed on the configuration area during an operation.

The division number calculator 451 calculates a division number Ndvd(≥2) used for dividing multiple FW application target RAID groups, into Ndvd groups. As an example, the division number calculator 451 may calculate the division number Ndvd in the following procedures (i) through (iv):

(i) An LV 53 that takes the longest time for reading and writing data, and the processing time LVtmax on the basis of that LV 53, are obtained among access-target LVs 53. Note that the time to read from and write to an LV 53 may be calculated (estimated) from the effective data amount and the data transfer rate, of that LV 53 registered in the hierarchical control server 4, using the formula: effective data amount/transfer rate, for example. The access-target LVs 53 are LVs 53, on which an execution of an I/O process, such as a read or write of data, is specified in a command issued from the host apparatus 7, for example.

(ii) The number of RAID groups Rdmax storing access-target LVs 53 is calculated.

(iii) Based on results of the above (i) and (ii), the division number Ndvd for applying disk firm is decided. The division number Ndvd may be decided from a calculation by the formula: Ndvd=(LVtmax/Tfw)+1, for example. The fraction of (LVtmax/Tfw) may be rounded up. Tfw is one example of an estimated value of FW application time for a single disk 51. Noted that because the type of the disks 51 in the same RAID group is the same, Tfw is equal to the FW application time of the entire RAID group.

(iv) When the division number Ndvd exceeds the number of FW application target RAID groups, an LV 53 that takes the second longest time for reading and writing data, the processing time LVtmax of that LV 53, and the RAID group number assigned to that LV 53, are calculated again, to decide the division number Ndvd. The process (iv) may be repeatedly executed until the division number Ndvd becomes equal to or smaller than the number of FW application target RAID groups.

In the above-described procedure, the division number calculator 451 may obtain information of the division number Ndvd, an LV 53 that takes the longest time for an I/O process, which is available in the division number Ndvd, the corresponding processing time LVtmax, and the RAID group number Rdmax to which that LV 53 belongs.

As described above, the division number calculator 451 is one example of an identifying unit configured to identify respective RAID groups to which a plurality of disks 51 to apply firmware belong, from a plurality of RAID groups that are process targets according to an access request from the host apparatus 7.

The priority decision unit 452 sets an FW application priority (hereinafter may also be referred to as the “priority” or “firm up priority”) to each of multiple RAID groups. The FW application priorities may correspond to the orders to apply the FW, and there may be Ndvd priorities, where Ndvd is the division number obtained by the division number calculator 451 (the number of steps of the division number Ndvd).

In other words, the priority decision unit 452 divides multiple RAID groups into Ndvd groups (hereinafter may also be referred to as “FW application groups”), and sets FW application priorities to those FW application groups.

As an example, the priority decision unit 452 may estimate the time LVtm to read or write all of access-target LVs 53 that are on-cache, and may set an FW application priority, for each RAID group, based on the estimate LVtm.

In one embodiment, while a RAID group to which the LV 53 having the longest I/O processing time belongs (hereinafter may also be referred to as the “longest RAID group”) handles an I/O process, the FW application controller 45 executes an FW application process on the other FW application groups. Note that the longest RAID group is a RAID group identified by an Rdmax obtained by the division number calculator 451.

The “longest RAID group” is one example of a RAID group, to which an LV 53 having the longest estimated value of I/O processing time on the basis of LV 53 belongs (e.g., the LV 53 having the processing time LVtmax), as described above. Accordingly, the priority decision unit 452 may assign the last or the second last priority (i.e., the order of an FW application) to the longest RAID group.

In the meantime, in the above-described formula to calculate the division number Ndvd, (LVtmax/Tfw) means that FW applications can be carried out (LVtmax/Tfw) times until an I/O process completes in the longest RAID group. Accordingly, the formula to calculate the division number Ndvd is regarded as the formula to obtain the sum of the count of FW applications that can be carried out until an I/O process completes in the longest RAID group, and the count of FW applications that are carried out on the longest RAID group itself (1).

Accordingly, when (LVtmax/Tfw) is dividable without a remainder, the time difference between the time when an I/O process completes in the longest RAID group, and the time when an FW application process is initiated, can be minimized by assigning the last priority to the longest RAID group (Rdmax). In contrast, when (LVtmax/Tfw) has a fraction, if the last priority is assigned to the longest RAID group, an I/O process in the longest RAID group will end during an FW application process on the FW application group with the second last priority. In such a case, an interval arises in which no I/O process is carried out during the FW application process, which may reduce the I/O process performance.

For the above reason, in order to optimize the processing time of an I/O process and the processing time of an FW application process, the priority decision unit 452 may set the second last priority to the longest RAID group (Rdmax) when the following conditions are satisfied:

For example, the priority decision unit 452 may calculate the fraction (decimal part) Ndecmax of (LVtmax/Tfw). Noted that when the value of Ndecmax is 0, the priority decision unit 452 corrects Ndecmax to 1. The priority decision unit 452 may also obtain an RAID group Rdmin having the shortest time LVtm, obtain the processing time LVtmin of Rdmin, and calculate the fraction (decimal part) Ndecmin of (LVtmin/Tfw).

The priority decision unit 452 may then compare Ndecmax and Ndecmin, and if Ndecmin is greater than Ndecmax, the priority decision unit 452 may determine that the conditions are satisfied and may set the second last priority to the longest RAID group Rdmax.

If Ndecmin is greater than Ndecmax, an FW application process on the Rdmin is carried out in the last round, and an I/O process on the Rdmin is carried out during an FW application process in the second last round (during an FW application process on the longest RAID group), for example. Also in this case, an I/O process on the Rdmin may end during the second last FW application process. Because Ndecmin is greater than Ndecmax, however, by assigning the last priority to Rdmin, the interval in which no I/O process is carried out during the second last FW application process can be reduced, as compared to a case where the last priority is assigned to Rdmax.

As set forth above, based on the conditional determinations as described above, the priority decision unit 452 sets the priority to carry out an FW application process in the last round, to one of the longest RAID group, and the RAID group having the smallest estimated value of the processing time LVtm. The priority decision unit 452 also sets the priority to carry out an FW application process in the second last round to the other. Thereby, the processing time of an I/O process and the processing time of an FW application process can be optimized.

Note that, when the second last priority is set to the longest RAID group Rdmax, an I/O process on the longest RAID group Rdmax may not be completed at the time when the third last FW application process completes. In this case, a start of the second last FW application process may be waited until the I/O process on the longest RAID group Rdmax completes.

As for the other priorities (e.g., the first to the third last priorities), the priority decision unit 452 may assign one priority to one or more RAID groups (FW application groups) in the descending order of the time LVtm. For example, a higher priority may be set to an RAID group having longer time LVtm (i.e., such that an RAID group having longer time LVtm have an earlier execution order of an FW application). This is because, by executing the FW application earlier, certain amount of time for carrying out an I/O process can be reserved after an application of the FW, and the processing time of the I/O process and the processing time of the FW application process can be optimized as a result.

As set forth above, the priority decision unit 452 is one example of a setting unit configured to set respective priorities for an application process of the FW to the RAID groups, based on estimated values of processing time according to the I/O request for each of the FW application target RAID groups.

The FW step-wise application unit 453 applies disk firm to RAID groups in a step-wise manner in the division number Ndvd rounds (steps), in accordance with the priorities decided by the priority decision unit 452.

In an FW application process in each round (step), an unmount of an FS 52 belonging to RAID groups included in an FW application group, a firm-up of disks 51 belonging to those RAID groups, and a mount of the unmounted FS 52, may be carried out, for example. The FW step-wise application unit 453 may instruct the FS controller 43 to carry out the mount and the unmount of the FS 52, for example.

When an access request from the host apparatus 7 is issued to an RAID group to which FW is being applied, the FW step-wise application unit 453 may set that access request to a waited state until the application of the FW completes. The FW step-wise application unit 453 may instruct the LV controller 42 to manage the waited state, for example.

As set forth above, the FW step-wise application unit 453 is one example of an application unit configured to execute the FW application process on disks 51 belonging to RAID groups to which the priorities are set, in execution orders in accordance with the priorities that are set by the priority decision unit 452.

### [1-3] Examples of Operations

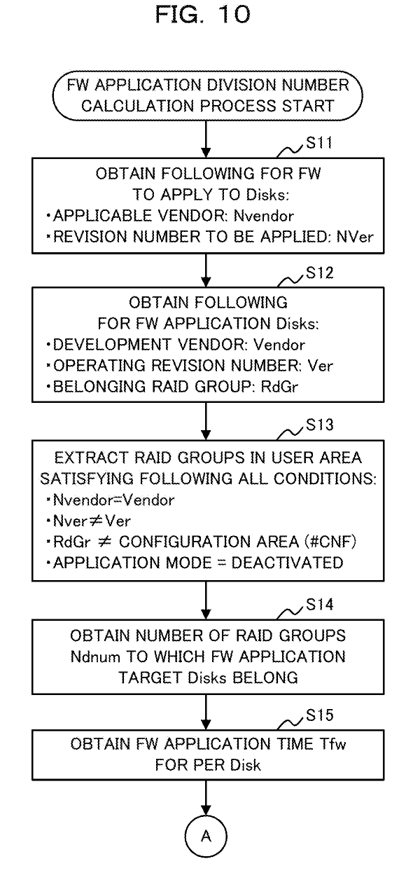

Next, referring to FIGS. 10-26, examples of operations of the virtual tape library apparatus 2 according to one embodiment will be described.

Note that the following descriptions assumes that an FW application process is carried out in parallel with an access to a large amount of data by the host apparatus 7. Examples of such a case include a case where an FW application instruction is received after an access is initiated in response to an access request received by the FW application controller 45, and a case where an FW application instruction is received simultaneously with an access request, for example.

[1-3-1] FW Application Division Number Calculation Process

Initially, an example of operations of an FW application division number calculation process by the division number calculator 451 will be described.

A disk firm name and an application mode (e.g., activated or deactivated) may be specified in an FW application instruction. The application mode indicates whether disk accesses are permitted or not during an application of FW, and “activated” specifies that accesses are permitted and “deactivated” specifies that accesses are not permitted.

As exemplified in FIG. 10, the division number calculator 451 obtains an applicable vendor Nvendor and a revision number to be applied NVer, for FW to apply to disks 51, based on the FW application instruction (Step S11).

The division number calculator 451 also obtains a development vendor Vendor, an operating revision number Ver, and a belonging RAID group RdGr, for each of the FW application target disks 51 (Step S12).

Subsequently, the division number calculator 451 extracts RAID groups in the user area which satisfy all of the following conditions (a) to (d) (Step S13).

(a) The applicable vendor Nvendor and the development vendor Vendor, specified in the FW application instruction, match.

(b) The operating revision number Ver of the disks 51 does not match the revision number to be applied NVer, specified in the FW application instruction.

(c) The belonging RAID group RdGr is used for the data area.

Noted that because an operation of the configuration area is required to be stopped for applying FW, the configuration area is excluded from FW application targets.

(d) The application mode has been set to deactivated.

The division number calculator 451 then obtains the number of RAID groups Ndnum to which the FW application target disks 51 belong (Step S14), and obtains FW application time Tfw per a single disk 51 (Step S15).

The FW application time Tfw may be included in the FW application instruction and may be obtained by the division number calculator 451 from the FW application instruction, or may be calculated based on information, such as the access performance of the disks 51 and the size of the FW to be applied, for example. In the process depicted in FIG. 10, the number of FW application target RAID groups is calculated.

Note that Steps S11 and S12 may be executed in inverse order. Furthermore, Steps S14 and S15 may be executed in inverse order, and Step S15 may be executed prior to Step S13.

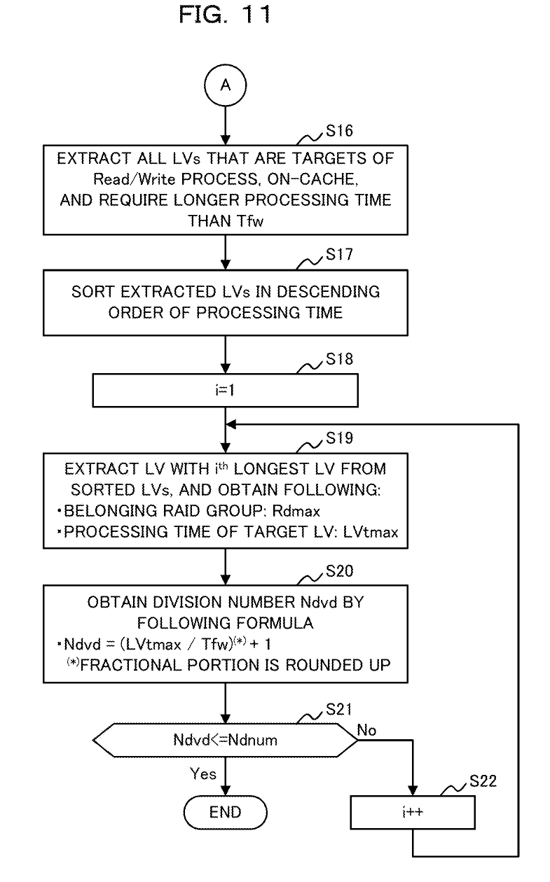

Next, as exemplified in FIG. 11, the division number calculator 451 extracts all of LVs 53 that are targets of read/write processes, are on-cache, and have I/O processing time longer than the FW application time Tfw (Step S16).

The division number calculator 451 then sorts the extracted LVs 53 in the descending order of processing time (Step S17).

The division number calculator 451 sets 1 to a variable i (Step S18), extracts the LV 53 having the i^{th} longest processing time, from the sorted LVs 53, and obtains the belonging RAID group Rdmax and the processing time LVtmax of the target LV (Step S19).

Subsequently, the division number calculator 451 determines the division number Ndvd=(LVtmax/Tfw)+1 (Step S20). Note that the fractional portion of (LVtmax/Tfw) is rounded up.

The division number calculator 451 determines whether or not the division number Ndvd that is calculated is equal to or less than Ndnum (Step S21). When Ndvd is equal to or less than Ndnum (the Yes from Step S21), the process ends. Note that the division number calculator 451 may save the division number Ndvd, LVtmax, and Rdmax, used in this step, into the memory 4b (refer to FIG. 4) or the like.

In contrast, when Ndvd is not equal to or less than Ndnum (i.e., Ndvd is greater than Ndnum) (the No from Step S21), the division number calculator 451 sets 1 to the variable i (Step S22) and the process transitions to Step S19.

In the above-described process, the FW application division number is obtained, based on an LV 53 and the belonging RAID group satisfying the conditions to execute an FW application process according to one embodiment, among LVs 53 that require a read/write process to the LVs 53 during an application of the FW. In the above-described example, one LV 53 satisfying the following conditions (A) to (C) is extracted.

(A) The LV 53 is in the on-cache state.

(B) A read/write process can be completed during the FW application process in the divided FW application group (Ndvd≤Ndnum).

(C) The LV 53 has an I/O processing time as long as possible (or at least the I/O processing time is longer than Tfw).

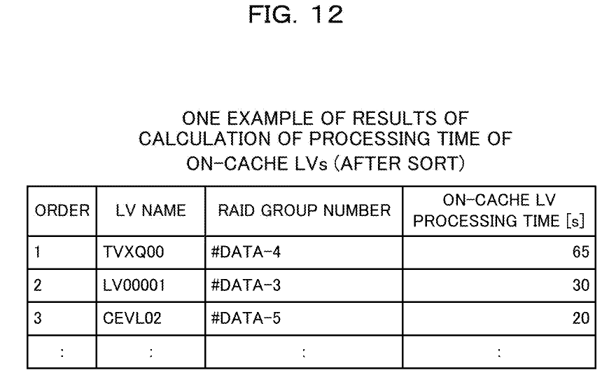

FIG. 12 depicts one example of calculation results of processing time of on-cache LVs 53 (after they are sorted). Note that the following descriptions assume that the number Ndnum of FW application target RAID groups is 5, and that the FW application time Tfw is 15 seconds.

As exemplified in FIG. 12, when the LVs 53 are sorted in the descending order of processing time, the following processing results are obtained in Steps S20 and S21 depicted in FIG. 11.

(1) For RAID group number “#DATA-4”: Ndvd=(65/15)+1=4.33 . . . (the fraction is rounded up)+1=6

As described above, a division number Ndvd is obtained as 6 in Step S20. In the decision in Step S21, Ndvd=6, LVtmax=65, and Rdmax=“#DATA-4” are not adopted because Ndvd is greater than Ndnum=5.

(2) For RAID group number “#DATA-3”: Ndvd=(30/15)+1=2+1=3

In the next loop, as described above, Ndvd is obtained as 3 in Step S20. In the decision in Step S21, Ndvd is equal to or less than Ndnum. Accordingly, the process ends, and Ndvd=3, LVtmax=30, Rdmax=“#DATA-3” are obtained.

[1-3-2] FW Application Priority Decision Process

Next, an example of operations of an FW application priority decision process by the priority decision unit 452 will be described. The process by the priority decision unit 452 may be executed after the FW application division number calculation process depicted in FIGS. 10 and 11 completes.

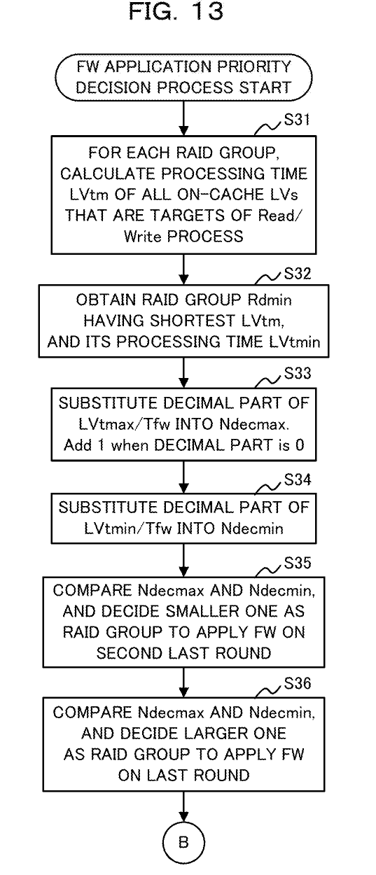

As exemplified in FIG. 13, the priority decision unit 452 calculates, for each RAID group, the processing time LVtm of all of on-cache LVs 53 that are targets of a read/write process (Step S31). Note that LVtm is set to 0 when there is no on-cache LV 53 in the RAID group.

Subsequently, the priority decision unit 452 obtains the RAID group Rdmin having the shortest LVtm. The priority decision unit 452 also obtains the processing time LVtm of that Rdmin, and substitutes LVtm into LVtmin. In the above processes, the priority decision unit 452 obtains the RAID group Rdmin and the processing time LVtmin of Rdmin (Step S32).

The priority decision unit 452 substitutes the decimal part of (LVtmax/Tfw) into Ndecmax (Step S33). In this case, when the decimal part is 0, 1 is added to Ndecmax. The priority decision unit 452 also substitutes the decimal part of (LVtmin/Tfw) into Ndecmin (Step S34).

The priority decision unit 452 then compares Ndecmax and Ndecmin, and decides the smaller one of Ndecmax and Ndecmin as an RAID group to which the FW is to be applied in the second last round (Step S35), and the larger one of Ndecmax and Ndecmin as an RAID group to which the FW is to be applied in the last round (Step S36). In the process depicted in FIG. 13, the RAID groups to which the FW is to be applied in the last and second last rounds, are decided.

Note that Step S33 and S34 may be executed in inverse order, and Step S33 may be executed prior to Step S32. In addition, Steps S35 and S36 may be executed in inverse order.

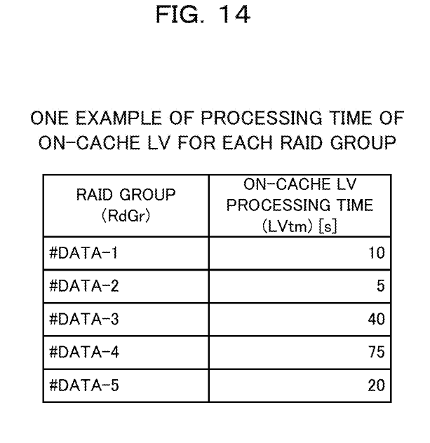

FIG. 14 depicts one example of processing time of on-cache LVs 53 for respective RAID groups. As exemplified in FIG. 14, when the processing time LVtm of all of the on-cache LVs 53 that are read/write targets, is calculated for each RAID group (corresponding to Step S31 in FIG. 13), the following processing results are obtained in Steps S32-S36 in FIG. 13:

Note that it is assumed that LVtmax, Rdmax, and Tfw are 30, “#DATA-3”, and 15, respectively, as obtained in the process in FIGS. 10 and 11.
Step S32: Rdmin=“#DATA-2” and LVtmin=5
Step S33: Ndecmax=the decimal part of (30/15=2.0)=0.0 (1 is added)=>1.0
Step S34: Ndecmin=the decimal part of (5/15=0.33 . . . )=0.33 . . .
Steps S35 and S36:

Ndecmax (=1.0)>Ndecmin (=0.33 . . . )

Rdmin “#DATA-2”=RAID group to which an FW is to be applied in the second last round

Rdmax “#DATA-3”=RAID group to which an FW is to be applied in the last round

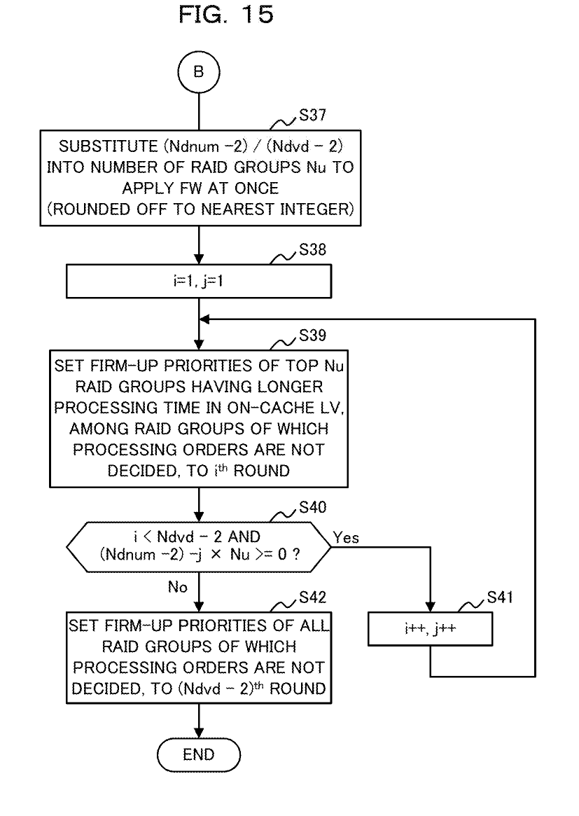

Next, as exemplified in FIG. 15, the priority decision unit 452 substitutes (Ndnum−2)/(Ndvd−2) into the number Nu of RAID groups to apply FW at once (i.e., the number of RAID groups to which the identical priority is set) (Step S37). Note that the priority decision unit 452 may round off (Ndnum−2)/(Ndvd−2) to the nearest integer. The reason to subtract 2 from Ndnum and Ndvd is because the two FW application groups have already been decided in the process in FIG. 13.

In addition, the priority decision unit 452 sets 1 to variables i and j (Step S38). Note that a single variable k may be used in place of the separate variables i and j.

Subsequently, the priority decision unit 452 sets the FW priority of the top Nu RAID groups having long processing time of on-cache LVs 53, among the RAID groups the processing orders of which have not been decided yet, to the i^{th} (Step S39).

The priority decision unit 452 then determines whether or not the conditions of i<Ndvd−2, and (Ndnum−2)−j×Nu≥0 are satisfied (Step S40).

When the above-described conditions are satisfied (the Yes from Step S40), in other words, there is any FW application group of which RAID group has not been set yet, and when there is any RAID group the processing order of which has not been decided yet, the process transitions to Step S41. In Step S41, the priority decision unit 452 adds 1 to i and j, and the process transitions to Step S39.

In contrast, when the above-described conditions are not satisfied (the No from Step S40), the priority decision unit 452 sets the (Ndvd−2)^{th} FW application priority to all of the RAID groups the processing orders of which have not been decided yet (Step S42) and the process ends.

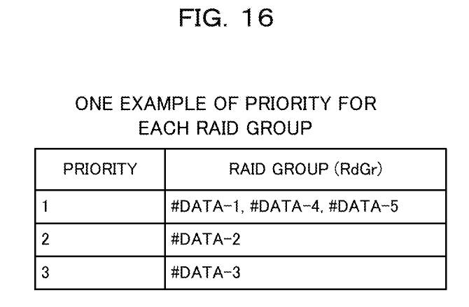

FIG. 16 depicts one example of priorities of the respective RAID groups. Note that it is assumed that Ndnum and Ndvd are 5 and 3, respectively, as obtained in the process in FIGS. 10 and 11.

In the Step S37 in FIG. 15, Nu=(5−2)/(3−2)=3 is obtained from the above values of Ndnum and Ndvd.

In the process in FIG. 13, the priorities for RdGr=“#DATA-2” and “DATA-3” have been decided. In Step S39 in FIG. 15, the priorities of Nu (=3) RAID groups of RdGr=“#DATA-1”, “#DATA-4”, and “#DATA-5”, the processing orders of which have not been decided yet, are set to the i^{th} (first).

In the example in FIG. 16, Ndvd=3, and the conditions in Step S40 are no more satisfied after Step S39 is executed when i=j=1. Furthermore, there is no RAID group the processing order of which has not been decided yet, and hence the process ends.

Note that, if Ndnum and Ndvd have greater values and the conditions in Step S40 are satisfied, the second, third, and so on priorities (FW application groups) are decided through the Yes route from Step S40.

[1-3-3] FW Application Process

Next, an example of operations of an FW application process by the FW step-wise application unit 453 will be described. The process by the FW step-wise application unit 453 may be executed after the FW application priority decision process in FIGS. 13 and 15 completes. The FW step-wise application unit 453 executes an FW application process on the basis of RAID group in the ascending order of the priorities.

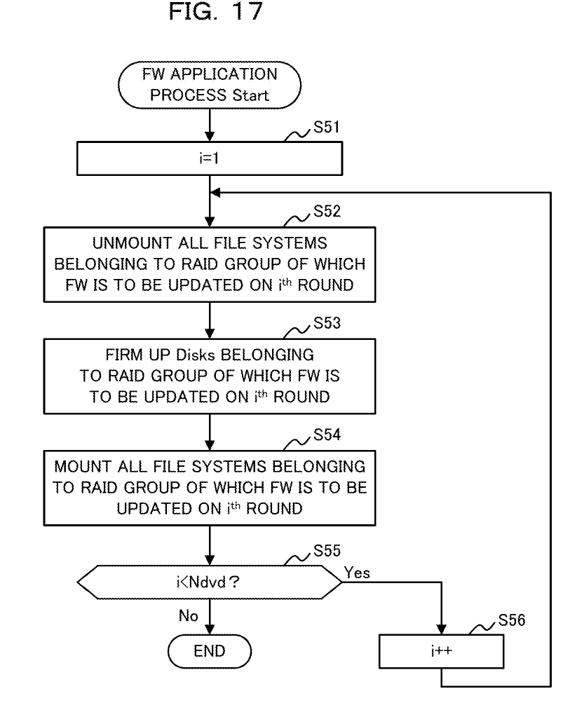

As exemplified in FIG. 17, the FW step-wise application unit 453 set 1 to a variable i (Step S51), and unmounts all FSs 52 belonging to an RAID group to be firmed up in the i^{th} round (Step S52).

Subsequently, the FW step-wise application unit 453 firms up all of the disks 51 belonging to the RAID group to be firmed up in the i^{th} round (Step S53).

The FW step-wise application unit 453 then mounts all of the FSs 52 belonging to the RAID group to be firmed up in the i^{th} round (Step S54).

The FW step-wise application unit 453 determines whether or not i is smaller than Ndvd (Step S55). When i is smaller than Ndvd (the Yes from Step S55), the FW step-wise application unit 453 adds 1 to i (Step S56) and the process transitions to Step S52.

In contrast, when i is not smaller than Ndvd (i.e., i is equal to or greater than Ndvd) (the No from Step S55), the FW step-wise application unit 453 ends the process.

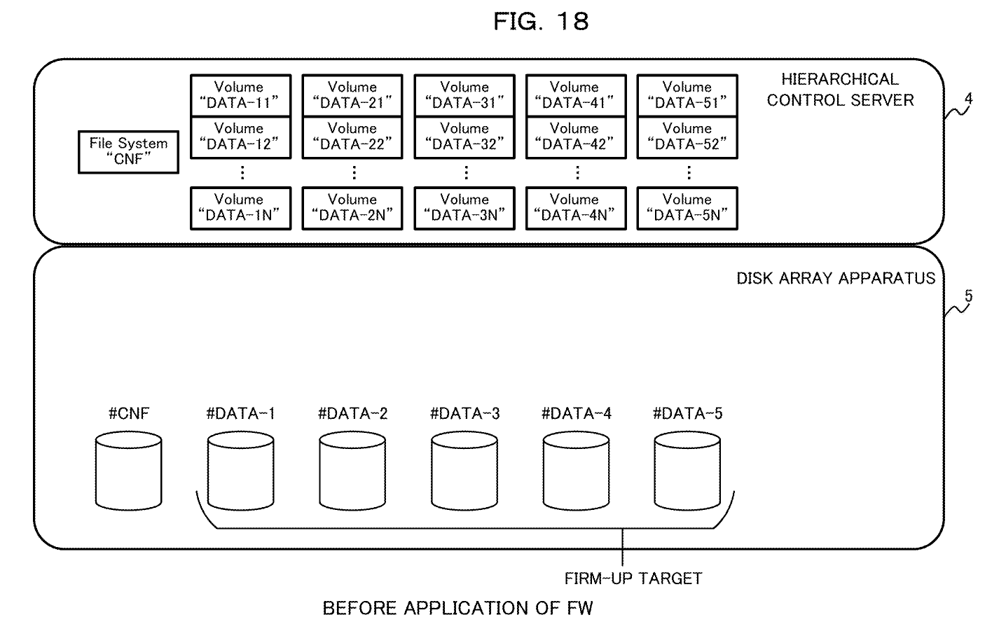

FIGS. 18-26 depict one example of the state transitions of the respective RAID groups, and one example of state transitions of the disk information table 411 and the file system information table 413. It is assumed that the priorities exemplified in FIG. 16 are used as FW application priorities.

—Before FW Application

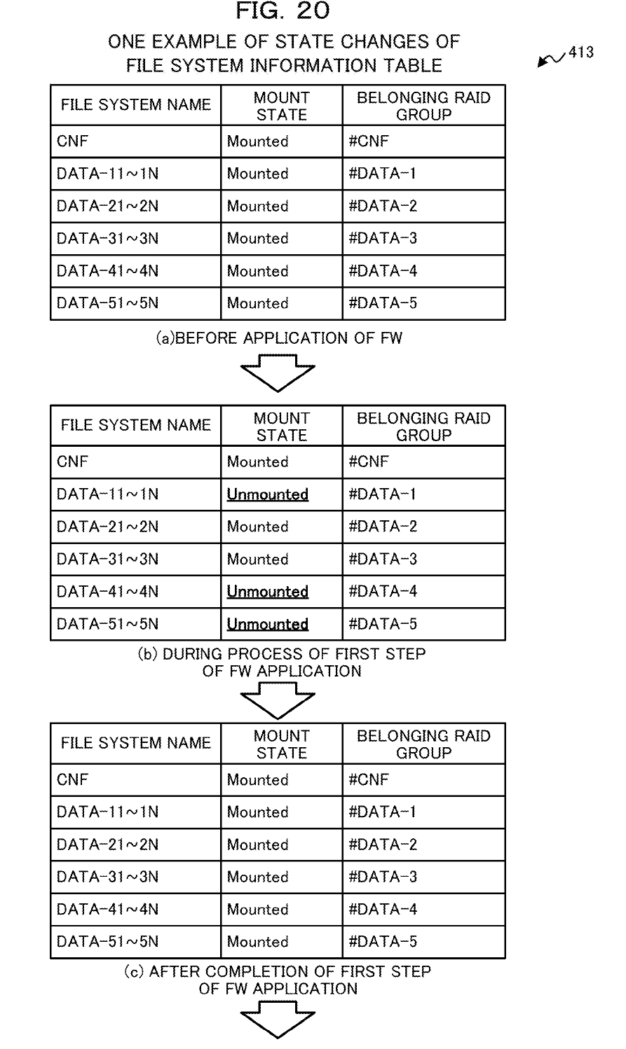

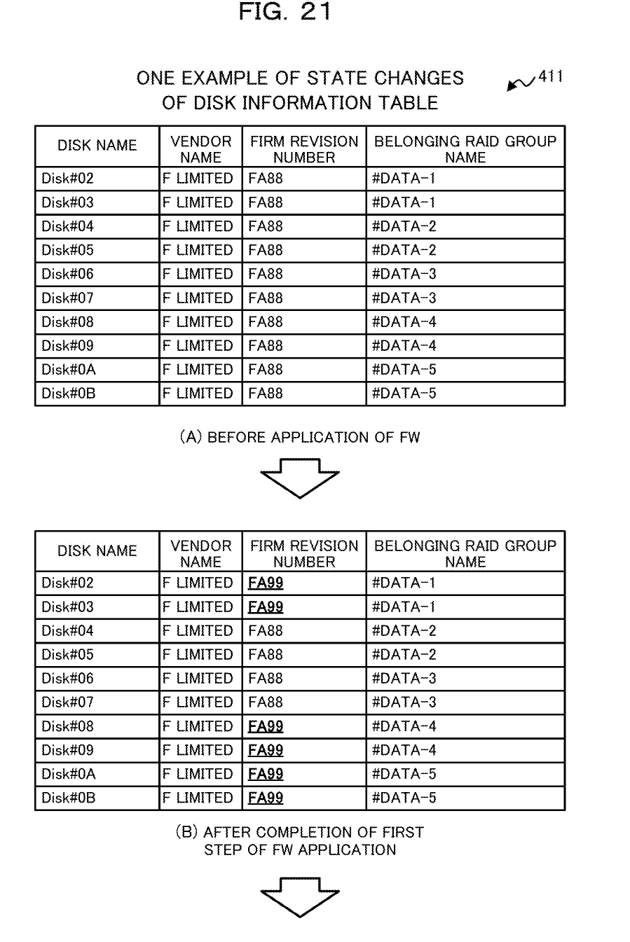

The states before an FW application are depicted in FIG. 18, (a) in FIG. 20, and (A) in FIG. 21. As depicted in FIG. 18, because the RAID group “#CNF” is used for a configuration area, the RAID group “#CNF” may be excluded from firm-up targets by the FW step-wise application unit 453. It is assumed that FSs 52 of “DATA-11 to DATA-1N” through “DATA-51 to DATA-5N” are mounted in the RAID groups “#DATA-1” through “#DATA-5”, respectively, in the hierarchical control server 4, and RAID groups “#DATA-1” through “#DATA-5” are firm-up targets.

As depicted in (a) in FIG. 20, the value “Mounted” indicating the mounted state is set to each FS 52 in the file system information table 413. Further, as depicted in (A) in FIG. 21, “FA88” is set to each disk 51 as the FW revision number.

In the following descriptions, it is assumed that the disks 51 of “Disk #02” through “Disk #0B” are FW application targets, and the revision number of FW to be applied is “FA99”.

—During Processing of First Step of FW Application (During Processing of FW Application with Priority of 1)

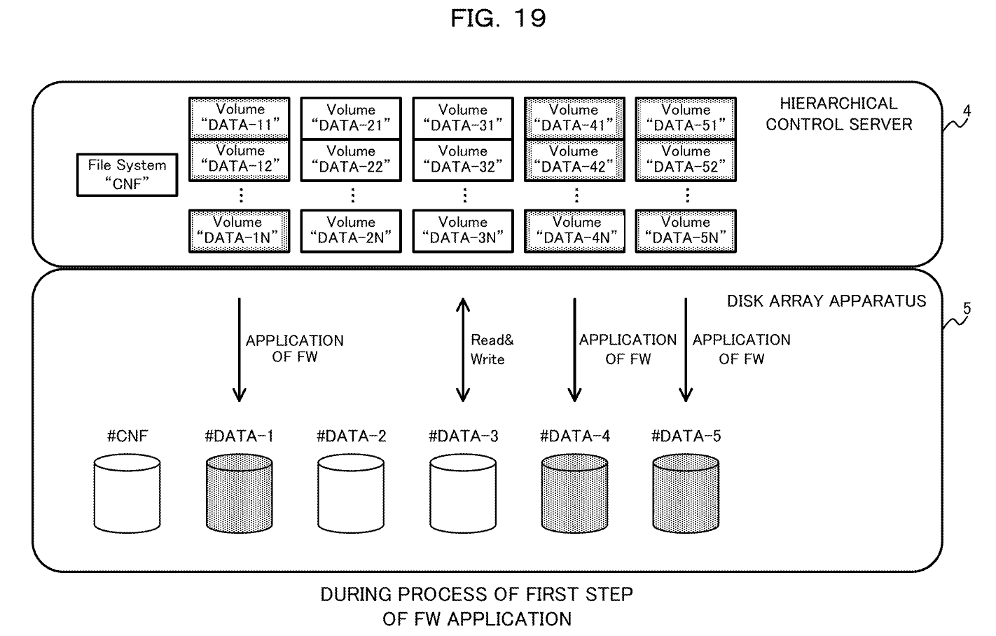

The states during processing of a first step of an FW application are depicted FIG. 19 and (b) in FIG. 20. As a result of updates of the management information 410 by the configuration manager 41, all FSs 52 belonging to FW application targets RdGr “#DATA-1”, “#DATA-4”, and “#DATA-5” are transitioned to the Unmounted state (refer to (b) in FIG. 20).

Furthermore, the FW is applied to the FW application targets RdGr by the FW step-wise application unit 453 (refer to FIG. 19). Note that when an access request (e.g., a read or write) is issued from the host apparatus 7 while the FW is being applied to the FW application targets RdGr, the FW step-wise application unit 453 may maintain the access request to the waited state until the first step of the FW application completes.

In the first step of an FW application, a read/write process on the RdGr “#DATA-3” may be executed.

—Completion of First Step of FW Application (Completion of FW Application with Priority of 1)

The states after the first step of an FW application completes are depicted in (c) in FIG. 20 and (B) in FIG. 21. As a result of updates of the management information 410 by the configuration manager 41, all of the FSs 52 belonging to the FW application targets RdGr are transitioned to the Mounted state (refer to (c) in FIG. 20), and the FW revision numbers of the corresponding disks 51 are updated to “FA99” (refer to (B) in FIG. 21).

—During Processing of Second Step of FW Application (During Processing of FW Application with Priority of 2)

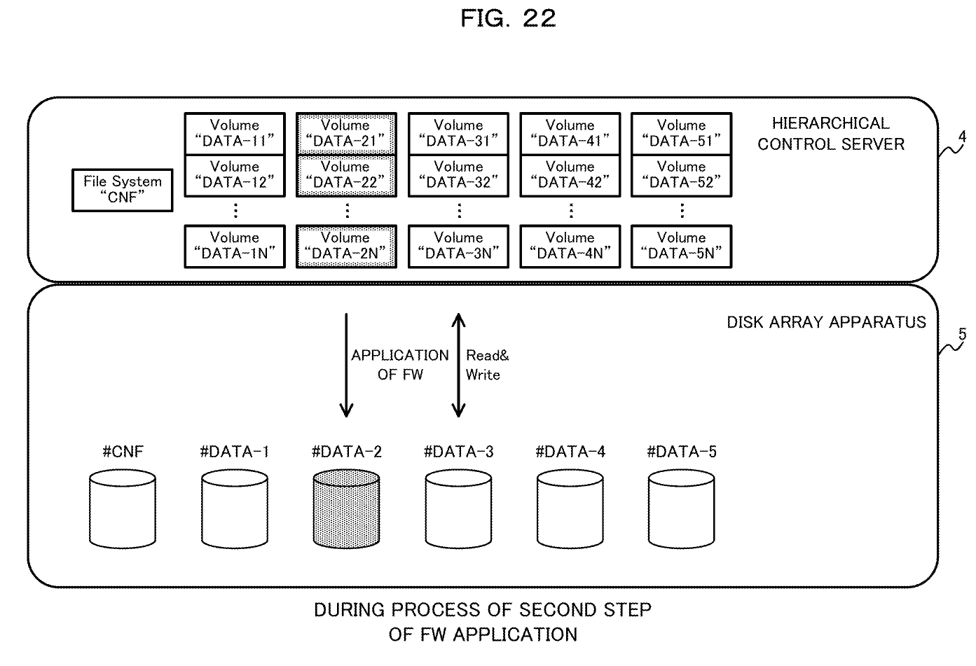

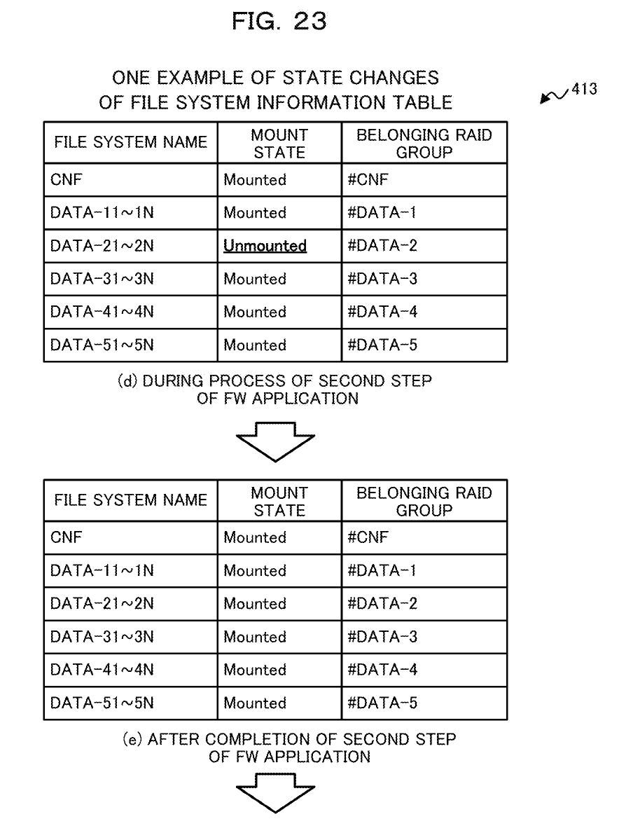

The states during processing of a second step of the FW application are depicted in FIG. 22 and (d) in FIG. 23. As a result of updates of the management information 410 by the configuration manager 41, all FSs 52 belonging to the FW application target RdGr “#DATA-2” are transitioned to the Unmounted state (refer to (d) in FIG. 23).

Furthermore, the FW is applied to the FW application target RdGr by the FW step-wise application unit 453 (refer to FIG. 22). Note that when an access request (e.g., a read or write) is issued from the host apparatus 7 during the application of the FW to the FW application targets RdGr, the FW step-wise application unit 453 may maintain the access request to the waited state until the second step of the FW application completes.

In the second step of the FW application, the read/write process on the RdGr “#DATA-3” may still be executed from the first step of an FW application.

—Completion of Second Step of FW Application (Completion of FW Application with Priority of 2)

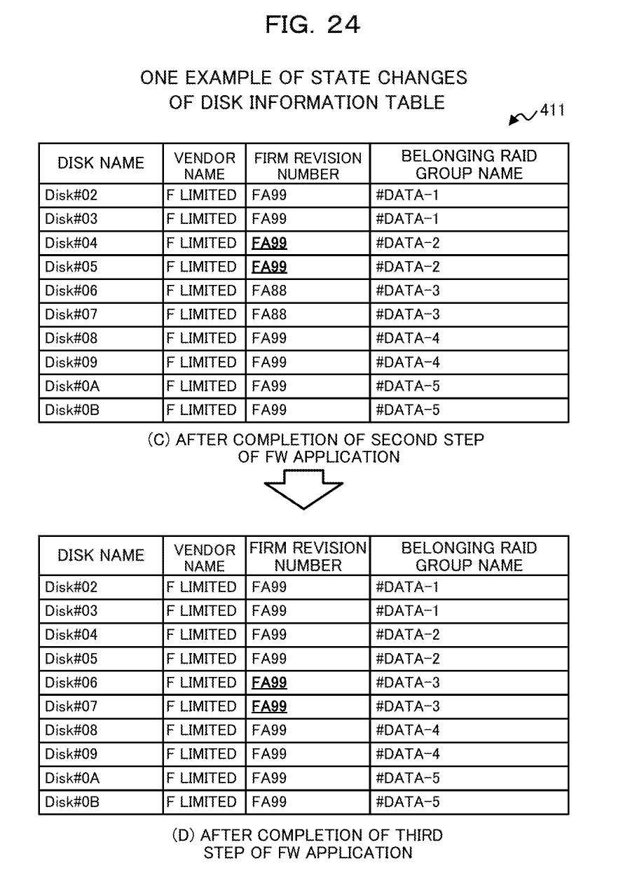

The states after the second step of the FW application completes are depicted in (e) in FIG. 23 and (C) in FIG. 24. As a result of updates of the management information 410 by the configuration manager 41, all of the FSs 52 belonging to the FW application target RdGr are transitioned to the Mounted state (refer to (e) in FIG. 23), and the FW revision numbers of the corresponding disks 51 is updated to “FA99” (refer to (C) in FIG. 24).

—During Processing of Third Step of FW Application (During Processing of FW Application with Priority of 3)

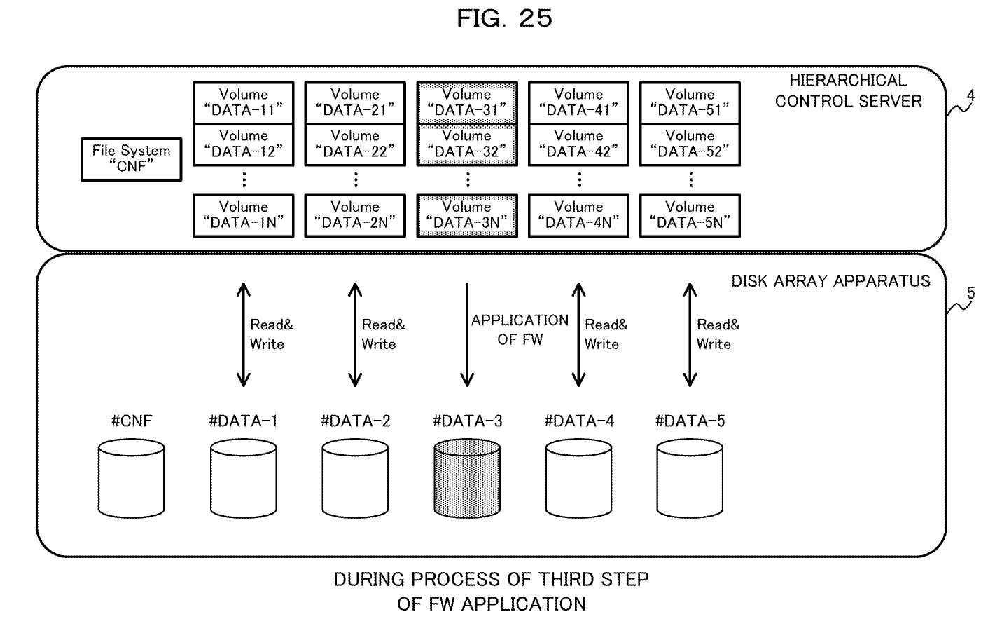

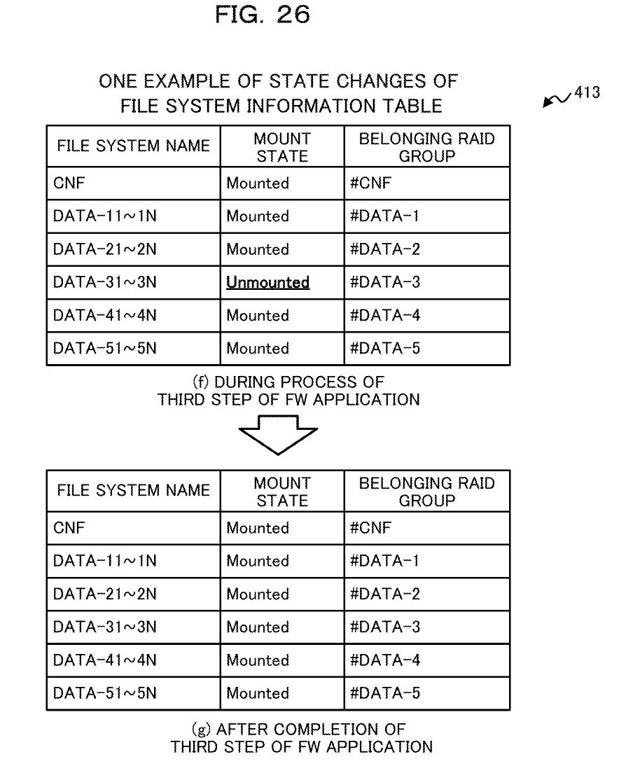

The states during processing of a third step of the FW application are depicted in FIG. 25 and (f) in FIG. 26. As a result of updates of the management information 410 by the configuration manager 41, all FSs 52 belonging to the FW application target RdGr “#DATA-3” are transitioned to the Unmounted state (refer to (f) in FIG. 26).

Furthermore, the FW is applied to the FW application target RdGr by the FW step-wise application unit 453 (refer to FIG. 25). Note that when an access request (e.g., a read or write) is issued from the host apparatus 7 during the application of the FW to the FW application target RdGr, the FW step-wise application unit 453 may maintain the access request to the waited state until the third step of the FW application completes.

In the third step of the FW application, read/write processes on the RdGr “#DATA-1”, “#DATA-2”, “#DATA-4”, and “#DATA-5” may be executed.

—Completion of Third Step of FW Application (Completion of FW Application with Priority of 3)

The states after the third step of the FW application completes are depicted in (g) in FIG. 26 and (D) in FIG. 24. As a result of updates of the management information 410 by the configuration manager 41, all of the FSs 52 belonging to the FW application target RdGr are transitioned to the Mounted state (refer to (g) in FIG. 26), and the FW revision numbers of the corresponding disks 51 are updated to “FA99” (refer to (D) in FIG. 24).

In the above-described process, in the virtual tape library apparatus 2, a process to read and write a large amount of data, such as a process for a full backup or a full restore of the system, and an FW application process can be executed simultaneously, and the processing time of the two processes can be optimized.

Note that, in the examples of states of first to third steps of the FW application process, the intervals in which read/write processes are carried out on respective RAID groups are not limited to those in the examples in FIGS. 19, 22, and 25. For example, the hierarchical control server 4 may carry out a read/write process on each RAID group in any intervals, as long as the interval does not overlap the interval of an FW application process on that RAID group. The interval to carry out read/write processes may be decided in accordance with the process performance of a control apparatus or the like in the hierarchical control server 4, the disk array apparatus 5 that processes I/Os, and the amount of I/O data.

### [2] Miscellaneous

The above-described technique according to one embodiment may be modified and practiced in the following modifications.

For example, in the hierarchical control server 4, the functions of the configuration manager 41, the LV controller 42, the FS controller 43, the PV controller 44, and the FW application controller 45 may be combined in any combination, or may be divided. In addition, in the FW application controller 45, the functions of the division number calculator 451, the priority decision unit 452, and the FW step-wise application unit 453 may be combined in any combination, or may be divided. Furthermore, at least a part of the above-identified functions of the hierarchical control server 4 may be included in an apparatus separate from the hierarchical control server 4.

While one embodiment has been described in cases where an FW is applied to disks 51 in the hierarchical control server 4 provided in the virtual tape library apparatus 2, this is not limiting. The technique according to one embodiment may be applied to a wide variety of storage apparatuses having multiple storing devices.

As an example, the technique according to one embodiment may be applied to a storage apparatus (e.g., scale out type storage) having multiple RAID apparatuses in which multiple storing devices are arranged in RAID configurations. In this case, the functions as the hierarchical control server 4 may be provided by a control apparatus, such as a controller module (CM) that controls the RAID apparatuses.

Further, while one embodiment has been described in which the tape library 6 employs magnetic tape cartridges, this is not limiting. For example, the technique according to one embodiment may be applied to the hierarchical control server 4 having an optical disk library that employs optical disks (e.g., CDs, DVDs, Blu-ray disks, or HVDs) or optical disk cartridges, in place of the tape library 6.

In one aspect, a reduction in the availability of a storage apparatus can be suppressed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage control apparatus comprising:
a memory; and
a processor coupled to the memory, the processor being configured to:
identify respective storage groups to which a plurality of storing devices to apply firmware belong, from a plurality of storage groups that are process targets according to an access request from an upper apparatus;
set respective priorities for an application process of the firmware to the identified storage groups, based on estimated values of processing time according to the access request for each of the identified storage groups;
execute the application process on storing devices belonging to storage groups to which the priorities are set, in execution orders in accordance with the priorities that are set; and,
execute a process according to the access request on storage groups other than the storage groups to which the application process is being executed.

2. The storage control apparatus according to claim 1, wherein the processor is configured to set the priorities such that the application process is executed in an earlier step as a storage group has a greater estimated value of processing time according to the access request.

3. The storage control apparatus according to claim 1, wherein the processor is configured to set the priorities such that the application process is executed on a last or second last step on a storage group to which a piece of data having a largest estimated value of the processing time on a data basis is allocated, of a plurality of pieces of data that are specified as access targets in the access request.

4. The storage control apparatus according to claim 3, wherein the processor is configured to set the priorities such that the application process is executed on the last step on one storage group of the storage group to which the piece of data having a largest estimated value of the processing time on the data basis is allocated, and a storage group having a smallest estimated value of processing time according to the access request, and the application process is executed on the second last step on the other storage group.

5. The storage control apparatus according to claim 1, wherein the processor is configured to decide a number of levels of the priorities based on the estimated value of the processing time on the data basis of the plurality of pieces of data that are specified as the access targets in the access request, processing time of the application process, and a number of identified storage groups.

6. The storage control apparatus according to claim 5, wherein the processor is configured to decide a number of storage groups to set an identical priority, based on the number of levels of the priorities, and the number of identified storage groups.

7. The storage control apparatus according to claim 1, wherein
the plurality of storage groups store, in a library apparatus accommodating a plurality of portable media, logical volumes of data stored in each of one or more portable media of the plurality of portable media, and
the processor is configured to identify a plurality of storage groups storing a logical volume specified as access targets in the access request, as the access target.

8. The storage control apparatus according to claim 1, wherein the processor is configured to exclude a storage group storing configuration information about the storage control apparatus, from the storage groups to be identified.

9. A storage apparatus comprising:
a plurality of storing devices; and
a storage control apparatus configured to control the plurality of storing devices, the storage control apparatus comprising:
a memory; and
a processor coupled to the memory, the processor being configured to:
identify respective storage groups to which a plurality of storing devices to apply firmware belong, from a plurality of storage groups that are process targets according to an access request from an upper apparatus;
set respective priorities for an application process of the firmware to the identified storage groups, based on estimated values of processing time according to the access request for each of the identified storage groups;
execute the application process on storing devices belonging to storage groups to which the priorities are set, in execution orders in accordance with the priorities that are set; and,
execute a process according to the access request on storage groups other than the storage groups to which the application process is being executed.

10. Anon-transitory computer-readable recording medium having stored therein a control program for causing a computer to execute a process comprising:
identifying respective storage groups to which a plurality of storing devices to apply firmware belong, from a plurality of storage groups that are process targets according to an access request from an upper apparatus;
setting respective priorities for an application process of the firmware to the identified storage groups, based on estimated values of processing time according to the access request for each of the identified storage groups;
executing the application process on storing devices belonging to storage groups to which the priorities are set, in execution orders in accordance with the priorities that are set; and,
executing a process according to the access request on storage groups other than the storage groups to which the application process is being executed.

11. The non-transitory computer-readable recording medium having the control program stored therein according to claim 10, wherein the setting sets the priorities such that the application process is executed in an earlier step as a storage group has a greater estimated value of processing time according to the access request.

12. The non-transitory computer-readable recording medium having the control program stored therein according to claim 10, wherein the setting sets the priorities such that the application process is executed on a last or second last step on a storage group to which a piece of data having a largest estimated value of the processing time on a data basis is allocated, of a plurality of pieces of data that are specified as access targets in the access request.

13. The non-transitory computer-readable recording medium having the control program stored therein according to claim 12, wherein the setting sets the priorities such that the application process is executed on the last step on one storage group of the storage group to which the piece of data having a largest estimated value of the processing time on the data basis is allocated, and a storage group having a smallest estimated value of processing time according to the access request, and the application process is executed on the second last step on the other storage group.

14. The non-transitory computer-readable recording medium having the control program stored therein according to claim 10, wherein the setting decides a number of levels of the priorities based on the estimated value of the processing time on the data basis of the plurality of pieces of data that are specified as the access targets in the access request, processing time of the application process, and a number of identified storage groups.

15. The non-transitory computer-readable recording medium having the control program stored therein according to claim 14, wherein the setting decides a number of storage groups to set an identical priority, based on the number of levels of the priorities, and the number of identified storage groups.

16. The non-transitory computer-readable recording medium having the control program stored therein according to claim 10, wherein
the plurality of storage groups store, in a library apparatus accommodating a plurality of portable media, logical volumes of data stored in each of one or more portable media of the plurality of portable media, and
the identifying identifies a plurality of storage groups storing a logical volume specified as access targets in the access request, as the access target.

17. The non-transitory computer-readable recording medium having the control program stored therein according to claim 10, wherein the identifying excludes a storage group storing configuration information about the storage control apparatus, from the identified storage groups.
